(19) United States
(12) Patent Application Publication
(10) Pub. No.: US 2020/0125285 A1
(43) Pub. Date: Apr. 23, 2020

(54) MEMORY SYSTEM AND OPERATING METHOD THEREOF

(71) Applicant: SK hynix Inc., Gyeonggi-do (KR)

(72) Inventor: Eu Joon BYUN, Gyeonggi-do (KR)

(21) Appl. No.: 16/223,304

(22) Filed: Dec. 18, 2018

(30) Foreign Application Priority Data
Oct. 18, 2018 (KR) 10-2018-0124655

(51) Int. Cl. G06F 3/06

(52) U.S. Cl. CPC G06F 3/0647; G06F 3/0604; G06F 3/0659; G06F 3/0673; G06F 3/064

(57) ABSTRACT

A memory system may include: a storage medium comprising a plurality of memory blocks each having a plurality of memory units; and a controller configured to read target data of a target logical address corresponding to a read request from the storage medium, wherein the controller comprises: a unit count manager configured to manage a unit count of the target logical address in a unit count list, and decide whether to perform a unit migration operation on a target memory unit having the target data stored therein based on the unit count; and a block count manager configured to manage a block count of a target memory block including the target memory unit in a block count list, and decide whether to perform a block migration operation on the target memory block based on the block count.

### CROSS-REFERENCE TO RELATED APPLICATION

The present application claims priority under 35 U.S.C. § 119(a) to Korean application number 10-2018-0124655, filed on Oct. 18, 2018, in the Korean Intellectual Property Office, which is incorporated herein by reference in its entirety.

### BACKGROUND

### 1. Technical Field

Various embodiments of the present disclosure generally relate to a memory system. Particularly, the embodiments relate to a memory system including a nonvolatile memory device.

### 2. Related Art

A memory system may be configured to store data provided from a host device in response to a write request of the host device. Also, the memory system may be configured to provide data stored therein to the host device in response to a read request of the host device. The host device may include a computer, digital camera, mobile phone or the like, as an electronic device capable of processing data. The memory system may be embedded in the host device or separately fabricated and connected to the host device.

### SUMMARY

Various embodiments are directed to a memory system capable of reducing resource and power consumption by suppressing an unnecessary block migration operation, and an operating method thereof.

In an embodiment, a memory system may include: a storage medium comprising a plurality of memory blocks each having a plurality of memory units; and a controller configured to read target data of a target logical address corresponding to a read request from the storage medium, wherein the controller comprises: a unit count manager configured to manage a unit count of the target logical address in a unit count list, and decide whether to perform a unit migration operation on a target memory unit having the target data stored therein based on the unit count; and a block count manager configured to manage a block count of a target memory block including the target memory unit in a block count list, and decide whether to perform a block migration operation on the target memory block based on the block count.

In an embodiment, there is provided an operating method of a memory system which includes: a storage medium including a plurality of memory blocks each having a plurality of memory units, and a controller configured to control the storage medium. The operating method may include: determining a unit count of a target logical address corresponding to a read request in a unit count list; performing a unit migration operation on a target memory unit in which target data of the target logical address is stored based on the unit count; determining a block count of a target memory block including the target memory unit in a block count list; and performing a block migration operation on the target memory block based on the block count.

### BRIEF DESCRIPTION OF THE DRAWINGS

FIG. 1 is a block diagram illustrating a memory system in accordance with an embodiment.

FIG. 2 illustrates a unit count list in accordance with an embodiment.

FIGS. 3A and 3B illustrate a method for managing a unit count list when a read request is received in accordance with an embodiment.

FIG. 4 illustrates a method in which a unit migration component performs a unit migration operation in accordance with an embodiment.

FIG. 5 illustrates a method for managing a block count list in accordance with an embodiment.

FIG. 6 illustrates a method in which a block migration component performs a block migration operation in accordance with an embodiment.

FIG. 7 is a flowchart illustrating an operating method of a memory system in accordance with an embodiment.

FIG. 8 is a diagram illustrating a data processing system including a solid state drive (SSD) in accordance with an embodiment.

FIG. 9 is a diagram illustrating a data processing system including a memory system in accordance with an embodiment.

FIG. 10 is a diagram illustrating a data processing system including a memory system in accordance with an embodiment.

FIG. 11 is a diagram illustrating a network system including a memory system in accordance with an embodiment.

FIG. 12 is a block diagram illustrating a nonvolatile memory device included in a memory system in accordance with an embodiment.

### DETAILED DESCRIPTION

The advantages and characteristics of the present disclosure and methods for achieving the advantages and characteristics will be described through the following embodiments with reference to the accompanying drawings. However, the present disclosure is not limited to the embodiments described herein, but may be embodied in different ways. The present embodiments are provided to describe the present disclosure in detail, such that those skilled in the art to which the present disclosure pertains can practice the invention. Also, throughout the specification, reference to “an embodiment” or the like is not necessarily to only one embodiment, and different references to any such phrase are not necessarily to the same embodiment(s).

The present embodiments are not limited to specific shapes illustrated in the drawings, which may be exaggerated for clarity. In this specification, specific terms are used. However, the terms are used to describe the subject matter of the present disclosure but not to limit the scope of the present disclosure or the claims.

In this specification, an expression such as ‘and/or’ may indicate inclusion of one or more of components listed before/after the expression. Moreover, an expression such as ‘connected/coupled’ may indicate that one element is directly connected/coupled to another element or indirectly connected/coupled to another element through one or more intervening elements. The terms of a singular form may include plural forms and vice versa, unless the context indicates otherwise. Furthermore, the meanings of ‘include’ and ‘comprise’ or ‘including’ and ‘comprising’ may specify a component, step, operation and element, but do not exclude the presence or addition of one or more other components, steps, operations and/or elements.

Various embodiments now will be described in detail with reference to the accompanying drawings.

FIG. 1 is a block diagram illustrating a memory system 10 in accordance with an embodiment.

The memory system 10 may be configured to store data provided from an external host device (not illustrated) in response to a write request of the host device. Also, the memory system 10 may be configured to provide data stored therein to the host device in response to a read request of the host device.

The memory system 10 may be configured as any of a personal computer memory card international association (PCMCIA) card, a compact flash (CF) card, a smart media card, a memory stick, various multimedia cards (e.g, MMC, eMMC, RS-MMC, and MMC-Micro), various secure digital cards (e.g., SD, Mini-SD, and Micro-SD), a universal flash storage (UFS), a solid state drive (SSD) and the like.

The memory system 10 may include a controller 100 and a storage medium 200.

The controller 100 may control overall operations of the memory system 10. The controller 100 may access the storage medium 200 to process a request of the host device. Furthermore, according to the request of the host device or although no request is provided from the host device, the controller 100 may access the storage medium 200 to perform an internal management operation or background operation of the memory system 10.

The controller 100 may include a unit count manager 110, a unit migration component 120, a block count manager 130, a block migration component 140, and a buffer memory 150.

The unit count manager 110 may manage a unit count list UNIT-LIST. The unit count list UNIT-LIST may include the entries of logical addresses corresponding to recent read requests from the host device. The recent read requests may be read requests received from the host device just before the present. Each of the entries of the unit count list UNIT-LIST may include the unit count of the corresponding logical address.

The number of entries which may be included in the unit count list UNIT-LIST may be limited. In other words, the unit count list UNIT-LIST may have a limited size.

When a read request is received from the host device, the unit count manager 110 may manage the unit count of a target logical address corresponding to the read request in the unit count list UNIT-LIST. Specifically, the unit count manager 110 may determine whether the unit count list UNIT-LIST includes the entry of the target logical address. When the unit count list UNIT-LIST includes the entry of the target logical address, the unit count manager 110 may increase the unit count of the target logical address at the entry of the target logical address.

When the unit count list UNIT-LIST does not include the entry of the target logical address, the unit count manager 110 may determine whether the unit count list UNIT-LIST is full. When the unit count list UNIT-LIST is not full, the unit count manager 110 may insert the entry of the target logical address into the unit count list UNIT-LIST, and increase the unit count of the target logical address.

When the unit count list UNIT-LIST is full, the unit count manager 110 may delete the entry of a victim logical address from the unit count list UNIT-LIST, insert the entry of the target logical address into the unit count list UNIT-LIST, and increase the unit count of the target logical address.

In an embodiment, the unit count manager 110 may select the logical address corresponding to the oldest read request, among the logical addresses of the entries included in the unit count list UNIT-LIST, as the victim logical address.

The unit count manager 110 may decide whether to perform a unit migration operation on a target memory unit, based on the unit count of the target logical address. The target memory unit may indicate a memory unit in which target data corresponding to the target logical address is stored in the storage medium 200.

Specifically, the unit count manager 110 may decide to perform the unit migration operation on the target memory unit, when the unit count of the target logical address exceeds a unit threshold value, which may be predetermined. On the other hand, the unit count manager 110 may decide not to perform the unit migration operation on the target memory unit, when the unit count of the target logical address does not exceed the unit threshold value.

The unit count manager 110 may delete the entry of the target logical address from the unit count list UNIT-LIST after the unit migration operation is performed on the target memory unit.

The unit count list UNIT-LIST may be stored in the unit count manager 110 as illustrated in FIG. 1, or stored in a separate memory (not illustrated) external to the unit count manager 110.

In an embodiment, the unit count list UNIT-LIST may be backed up in the storage medium 200 or a separate nonvolatile memory, if necessary or desired.

In an embodiment, the unit count list UNIT-LIST may be managed in a volatile memory, and lost when the memory system 10 is powered off. In this case, the unit count list UNIT-LIST may include no entries when the memory system 10 is powered on again. Therefore, until the unit count list UNIT-LIST is full after the memory system 10 is powered on, the unit count manager 110 may add the entries of logical addresses corresponding to read requests into the unit count list UNIT-LIST.

The unit migration component 120 may perform the unit migration operation on the target memory unit according to the decision of the unit count manager 110. The unit migration component 120 may perform the unit migration operation on the target memory unit by migrating only target data of the target logical address from a memory block, i.e., a target memory block, into another memory block. The target memory block may indicate a memory block including the target memory unit among memory blocks MB of the storage medium 200.

The block count manager 130 may manage a block count list MB-LIST. The block count list MB-LIST may include block addresses of the memory blocks MB included in the storage medium 200 and block counts corresponding to the respective block addresses. When a read request is received from the host device, the block count manager 130 may increase the block count of the target memory block in the block count list MB-LIST, independently of the operations of the unit count manager 110 and the unit migration component 120.

The block count manager 130 may decide whether to perform a block migration operation on the target memory block based on the block count of the target memory block. Specifically, the block count manager 130 may decide to perform the block migration operation on the target memory block, when the block count of the target memory block exceeds a block threshold value. On the other hand, the block count manager 130 may decide not to perform the block migration operation on the target memory block, when the block count of the target memory block does not exceed the block threshold value.

The block count manager 130 may reset the block count of the target memory block in the block count list MB-LIST after the block migration operation is performed on the target memory block.

The block migration component 140 may perform the block migration operation on the target memory block according to the decision of the block count manager 130. The block migration component 140 may perform the block migration operation on the target memory block by migrating valid data stored in the target memory block into another memory block.

The unit threshold value and the block threshold value may be set to appropriate values based on experiments and/or operating parameters. For example, the block threshold value may be set to a value less than the number of read requests, which makes it impossible to recover data. For example, the unit threshold value may be set to a value less than the block threshold value.

The buffer memory 150 may temporarily store the target data of the target logical address read from the storage medium 200 until the target data is transferred to the host device.

In an embodiment, the unit migration component 120 may store the target data temporarily stored in the buffer memory 150 into a new position of the storage medium 200, when performing the unit migration operation. That is, for the unit migration operation, the unit migration component 120 may use the data temporarily stored in the buffer memory 150 without reading the data of the target logical address again from the storage medium 200.

In short, since hot data which are frequently requested are migrated into another memory block by the unit migration operation, the other data of the target memory block in which the hot data had been originally stored may not be damaged by the reading of the hot data any more, and the block count of the target memory block may not be further increased. Therefore, the memory system 10 in accordance with an embodiment may suppress increase in block count of the target memory block, thereby preventing an unnecessary block migration operation. Since the block migration operation migrates all the valid data of the target memory block, the block migration operation may require significant resource(s) and power consumption. The memory system 10 may suppress such a block migration operation, thereby improving the operation performance thereof.

The storage medium 200 may store data transferred from the controller 100, or read data stored therein and transfer the read data to the controller 100, under control of the controller 100. The storage medium 200 may include a plurality of nonvolatile memory devices (not illustrated). The nonvolatile memory devices may include any of a flash memory, such as a NAND flash or a NOR flash, a ferroelectric random access memory (FeRAM), a phase-change random access memory (PCRAM), a magnetoresistive random access memory (MRAM), a resistive random access memory (ReRAM or RRAM), and the like.

The storage medium 200 may include a plurality of memory blocks MB which are distributed in nonvolatile memory devices. The memory block MB may correspond to the unit by which the nonvolatile memory device performs an erase operation.

Each of the memory blocks MB may include a plurality of memory units MU. Each of the memory units MU may correspond to the unit by which the nonvolatile memory device performs a read operation. When data are stored in a memory unit MU, the corresponding memory unit MU may be mapped to the logical address of the corresponding data.

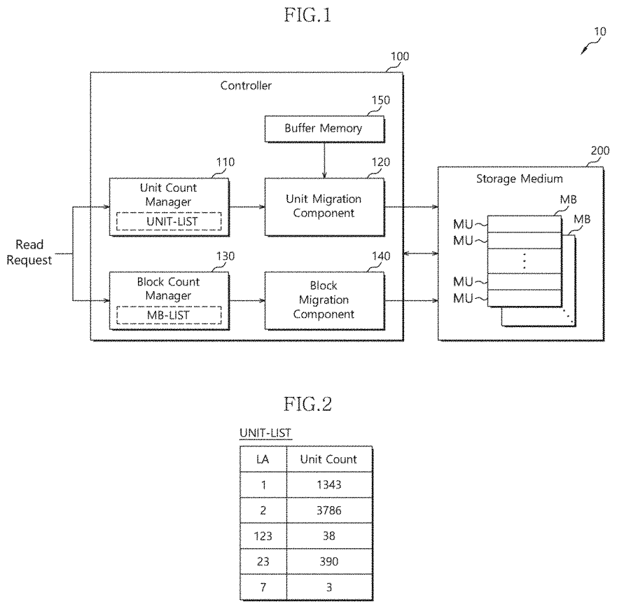

FIG. 2 illustrates a unit count list UNIT-LIST in accordance with an embodiment.

Referring to FIG. 2, the unit count list UNIT-LIST may include a plurality of entries, e.g., five entries. Each of the entries may include a logical address LA corresponding to a recent read request from the host device and a unit count corresponding to the logical address LA.

The unit count may indicate the number of read requests for the corresponding logical address. The counting point of the unit count may indicate the point of time when the corresponding logical address is included in the unit count list UNIT-LIST. In other words, the unit count may indicate a value obtained by counting the read request for the corresponding logical address whenever the read request is received, while the corresponding logical address stays in the unit count list UNIT-LIST..

Although FIG. 2 illustrates that the number of entries included in the unit count list UNIT-LIST is 5, the present invention is not limited thereto. The unit count list UNIT-LIST may be configured to include any number of entries that can be accommodated by the memory capacity allocated to the unit count list UNIT-LIST. The unit count list UNIT-LIST may be managed as a first-in first-out (FIFO) queue, for example.

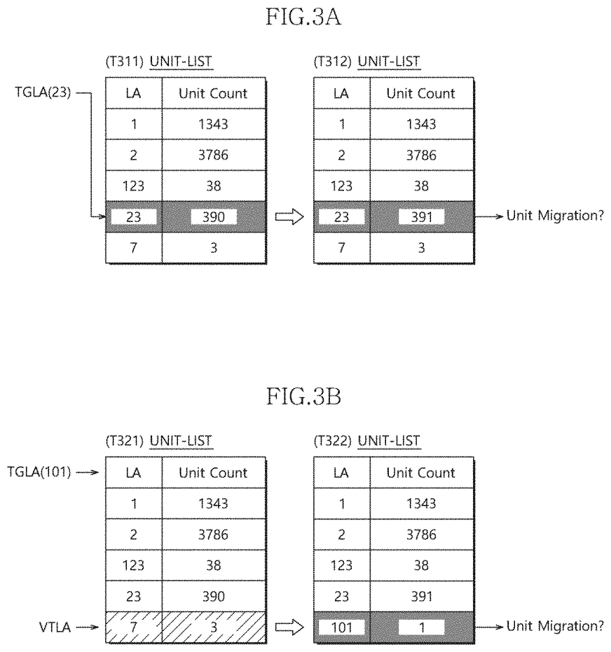

FIGS. 3A and 3B illustrate a method for managing a unit count list UNIT-LIST when a read request is received in accordance with an embodiment. FIG. 3A illustrates that the unit count list UNIT-LIST includes the entry of a target logical address TGLA corresponding to a read request when the read request is received. FIG. 3B illustrates that the unit count list UNIT-LIST does not include the entry of a target logical address TGLA corresponding to a read request when the read request is received.

Referring to FIG. 3A, the target logical address TGLA corresponding to the read request may be 23. At time T311, the unit count manager 110 may determine that the unit count list UNIT-LIST includes the entry (shaded) of the target logical address TGLA. Therefore, at time T312, the unit count manager 110 may increase the unit count of the target logical address TGLA 23 from 390 to 391 in the unit count list UNIT-LIST.

The unit count manager 110 may decide whether to perform a unit migration operation on the target memory unit in which data of the target logical address TGLA 23 is stored based on the increased unit count of the target logical address TGLA 23. Specifically, the unit count manager 110 may compare the unit count 391 of the target logical address TGLA with the unit threshold value, and decide whether to perform the unit migration operation based on the comparison result. For example, the unit count manager 110 may decide to perform the unit migration operation on the target memory unit, when the unit count 391 of the target logical address TGLA exceeds the unit threshold value. Furthermore, the unit count manager 110 may decide not to perform the unit migration operation on the target memory unit, when the unit count 391 of the target logical address TGLA does not exceed the unit threshold value.

When the unit migration operation is performed on the target memory unit, the unit count manager 110 may delete the entry of the target logical address TGLA 23 from the unit count list UNIT-LIST.

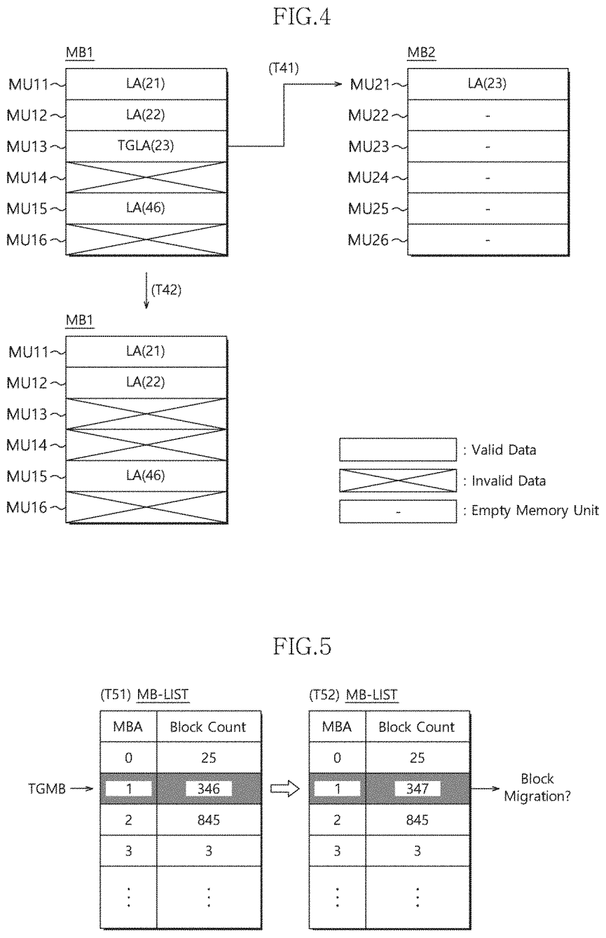

The method for performing the unit migration operation according to the decision of the unit count manager 110 will be described in detail with reference to FIG. 4.

Referring to FIG. 3B, the target logical address TGLA corresponding to the read request may be 101. At time T321, the unit count manager 110 may determine that the unit count list UNIT-LIST does not include the entry of the target logical address TGLA 101.

In this case, at time T321, the unit count manager 110 may select a logical address 7 as a victim logical address VTLA in the unit count list UNIT-LIST, and delete the entry (slashed) of the victim logical address VTLA from the unit count list UNIT-LIST. At time T322, the unit count manager 110 may insert the entry (shaded) of the target logical address TGLA 101 into the unit count list UNIT-LIST, and increase the unit count of the target logical address TGLA 101 to 1.

At time point T321, the unit count manager 110 may select the logical address corresponding to the oldest read request, among the logical addresses LA of the entries in the unit count list UNIT-LIST, as the victim logical address VTLA.

As described above, the unit count manager 110 may decide whether to perform the unit migration operation on the target memory unit in which data of the target logical address TGLA 101 is stored based on the increased unit count 1 of the target logical address TGLA 101.

FIG. 4 illustrates a method in which a unit migration component 120 performs the unit migration operation in accordance with an embodiment.

Referring to FIG. 4, the unit migration component 120 may perform the unit migration operation on a target memory unit MU13 in which the data of the target logical address TGLA 23 is stored according to the decision of the unit count manager 110. In FIG. 4, a memory block MB1 including the target memory unit MU13 may be the target memory block.

Specifically, at tune 141, the unit migration component 120 may copy the data of the target logical address TGLA 23, stored in the target memory unit MU13 of the target memory block MB1, into a memory unit MU21 of a memory block MB2. Then, at time T42, the unit migration component 120 may invalidate the data of the target logical address TGLA 23, stored in the target memory unit MU13, in the target memory block MB1.

Therefore, when a read request for the logical address LA 23 is subsequently received from the host device, the memory system 10 may read the data of the logical address LA 23 from the memory unit MU21 instead of the memory unit MU13, and transfer the read data to the host device.

The memory block MB2 into which the data are copied may be a memory block which is separately allocated for the unit migration operation. Then, when a unit migration operation is performed on another logical address, data of the corresponding logical address may be copied into a memory unit of the memory block MB2.

As described above, the data which is actually stored in the memory unit MU21 when the unit migration operation is performed may indicate data which is read from the target memory unit MU13 and temporary stored in the buffer memory 150 so as to be transferred to the host device according to the read request.

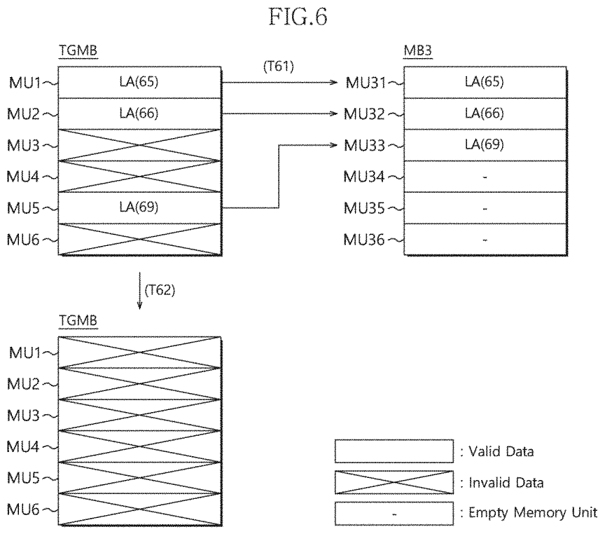

FIG. 5 illustrates a method for managing a block count list MB-LIST in accordance with an embodiment.

Referring to FIG. 5, the block count list MB-LIST may include block addresses MBA of memory blocks MB in the storage medium 200 and block counts corresponding to the block addresses MBA. Each of the block counts may indicate the number of read requests for the corresponding block address MBA.

At time T51, a read request for a target memory block TGMB of a block address MBA 1 may be received. As described above, the target memory block TGMB may indicate a memory block including a target memory unit in which data corresponding to the read request is stored.

At time T52, the block count manager 130 may increase the block count of the target memory block TGMB from 346 to 347 in the block count list MB-LIST.

The block count manager 130 may decide whether to perform a block migration operation on the target memory block TGMB based on the increased block count 347 of the target memory block TGMB. Specifically, the block count manager 130 may decide whether to perform the block migration operation on the target memory block TGMB, by comparing the block count 347 of the target memory block TGMB with the block threshold value. For example, the block count manager 130 may decide to perform the block migration operation on the target memory block TGMB, when the block count 347 of the target memory block TGMB exceeds the block threshold value. On the other hand, the block count manager 130 may decide not to perform the block migration operation on the target memory block TGMB, when the block count 347 of the target memory block TGMB does not exceed the block threshold value.

The block count manager 130 may reset the block count of the target memory block TGMB in the block count list MB-LIST to zero (0), after the block migration operation is performed on the target memory block TGMB.

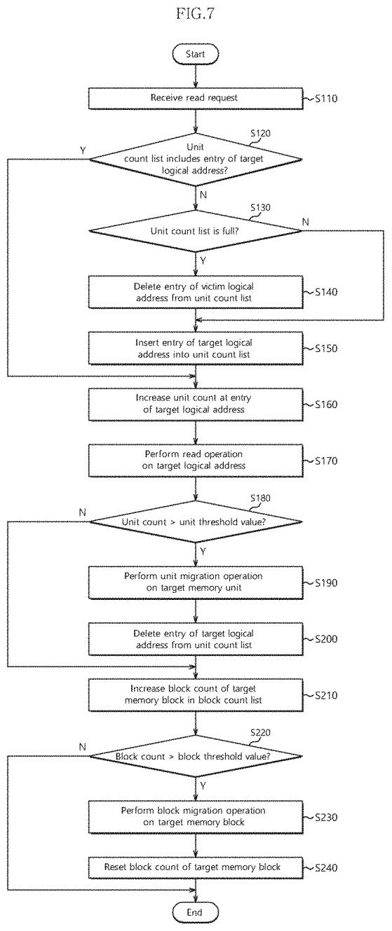

The method of performing the block migration operation according to the decision of the block count manager 130 will be described in detail with reference to FIG. 6.

FIG. 6 illustrates a method in which a block migration component 140 performs a block migration operation in accordance with an embodiment.

Referring to FIG. 6, the block migration component 140 may perform the block migration operation on the target memory block TGMB according to the decision of the block count manager 130.

Specifically, at time T61, the block migration component 140 may copy valid data of logical addresses LA65, LA66 and LA69, stored in memory units MU1, MU2 and M5 of the target memory block TGMB, into memory units MU31, MU32 and MU33 respectively of a memory block MB3. At time T62, the block migration component 140 may invalidate the data stored in the memory units MU1, MU2 and MU5 in the target memory block TGMB. Thus, since the target memory block TGMB includes no more valid data, the entire target memory block TGMB may be erased and then used to store other data.

The memory block MB3 into which the data are copied may be a memory block which is separately allocated for the block migration operation. In an embodiment, the memory block MB2 allocated for the unit migration operation in FIG. 4 may be different from or the same as the memory block MB3 allocated for the block migration operation in FIG. 6.

FIG. 7 is a flowchart illustrating an operating method of a memory system 10 in accordance with an embodiment.

Referring to FIG. 7, at step S110, the memory system 10 may receive a read request from a host device.

At step S120, the unit count manager 110 may determine whether the unit count list UNIT-LIST includes the entry of a target logical address corresponding to the read request. When the unit count list UNIT-LIST includes the entry of the target logical address (S120, Y), the method may proceed to step S160. However, when the unit count list UNIT-LIST does not include the entry of the target logical address (S120, N), the method may proceed to step S130.

At step S130, the unit count manager 110 may determine whether the unit count list UNIT-LIST is full. When the unit count list UNIT-LIST is not full (S130, N), the method may proceed to step S150. However, when the unit count list UNIT-LIST is full (S130, Y), the method may proceed to step S140.

At step S140, the unit count manager 110 may delete the entry of a victim logical address from the unit count list UNIT-LIST. The unit count manager 110 may select the logical address corresponding to the oldest read request, among the logical addresses of the entries included in the unit count list UNIT-LIST, as the victim logical address.

At step S150, the unit count manager 110 may insert the entry of the target logical address into the unit count list UNIT-LIST.

At step S160, the unit count manager 110 may increase the unit count of the target logical address at the entry of the target logical address.

At step S170, the controller 100 may perform a read operation on the target logical address. Specifically, the controller 100 may read target data corresponding to the target logical address from the storage medium 200 into the buffer memory 150. Further, the controller 100 may transfer the target data stored in the buffer memory 150 to the host device.

At step S180, the unit count manager 110 may determine whether the unit count of the target logical address exceeds a unit threshold value, which may be predetermined. When the unit count of the target logical address does not exceed the unit threshold value (S180, N), the method may proceed to step S210. However, when the unit count of the target logical address exceeds the unit threshold value (S180, Y), the method may proceed to step S190.

At step S190, the unit count manager 110 may decide to perform the unit migration operation on the target memory unit in which the target data of the target logical address is stored. The unit migration component 120 may perform the unit migration operation on the target memory unit according to the decision of the unit count manager 110.

At step S200, the unit count manager 110 may delete the entry of the target logical address from the unit count list UNIT-LIST.

At step S210, the block count manager 130 may increase the block count of the target memory block including the target memory unit in the block count list MB-LIST.

At step S220, the block count manager 130 may determine whether the block count of the target memory block exceeds a predetermined block threshold value. When the block count of the target memory block does not exceed the block threshold value (S220, N), the method may end. However, when the block count of the target memory block exceeds the block threshold value (S220, Y), the method may proceed to step S230.

At step S230, the block count manager 130 may decide to perform the block migration operation on the target memory block. The block migration component 140 may perform the block migration operation on the target memory block according to the decision of the block count manager 130.

At step S240, the block count manager 130 may reset the block count of the target memory block in the block count list MB-LIST.

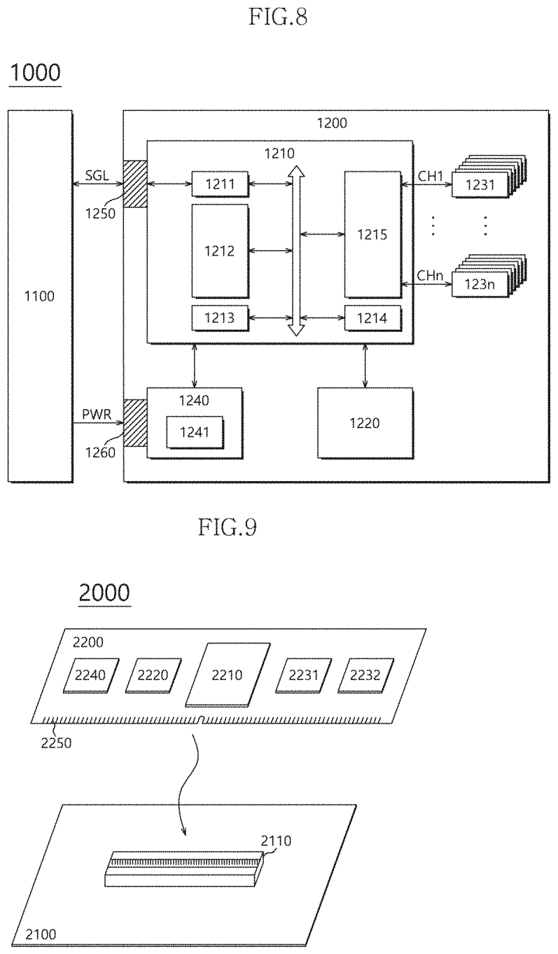

FIG. 8 is a diagram illustrating a data processing system 1000 including a solid state drive (SSD) 1200 in accordance with an embodiment. Referring to FIG. 8, the data processing system 1000 may include a host device 1100 and the SSD 1200.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operations of the SSD 1200. The controller 1210 may include a host interface 1211, a control component 1212, a random access memory 1213, an error correction code (ECC) component 1214, and a memory interface 1215.

The host interface 1211 may exchange a signal SGL with the host device 1100 through the signal connector 1250. The signal SGL may include a command, an address, data, and the like. The host interface 1211 may interface the host device 1100 and the SSD 1200 according to the protocol of the host device 1100. For example, the host interface 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-e or PCIe) and universal flash storage (UFS).

The control component 1212 may analyze and process the signal SGL received from the host device 1100. The control component 1212 may control operations of internal function blocks according to firmware or software for driving the SSD 1200. The random access memory 1213 may be used as a working memory for driving such firmware or software.

The control component 1212 may include a unit count manager 110, a unit migration component 120, a block count manager 130, and a block migration component 140 shown in FIG. 1.

The ECC component 1214 may generate the parity data for data to be transmitted to at least one of the nonvolatile memory devices 1231 to 123n. The generated parity data may be stored together with the data in the nonvolatile memory devices 1231 to 123n. The ECC component 1214 may detect an error of the data read from at least one of the nonvolatile memory devices 1231 to 123n, based on the parity data. If a detected error is within a correctable range, the ECC component 1214 may correct the detected error.

The memory interface 1215 may provide control signals such as commands and addresses to at least one of the nonvolatile memory devices 1231 to 123n according to control of the control component 1212. Moreover, the memory interface 1215 may exchange data with at least one of the nonvolatile memory devices 1231 to 123n according to control of the control component 1212. For example, the memory interface 1215 may provide the data stored in the buffer memory device 1220, to at least one of the nonvolatile memory devices 1231 to 123n. Further, the memory interface 1215 may provide the data read from at least one of the nonvolatile memory devices 1231 to 123n to the buffer memory device 1220.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured by various types of connectors depending on an interface scheme between the host device 1100 and the SSD 1200.

The power connector 1260 may be configured by various types of connectors depending on a power supply scheme of the host device 1100.

FIG. 9 is a diagram illustrating a data processing system 2000 including a memory system 2200 in accordance with an embodiment. Referring to FIG. 9, the data processing system 2000 may include a host device 2100 and the memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operations of the memory system 2200. The controller 2210 may be configured in the same manner as the controller 1210 shown in FIG. 8.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250, to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the memory system 2200. The connection terminal 2250 may be configured as any of various types depending on an interface scheme between the host device 2100 and the memory system 2200. The connection terminal 2250 may be disposed on or in any side of the memory system 2200.

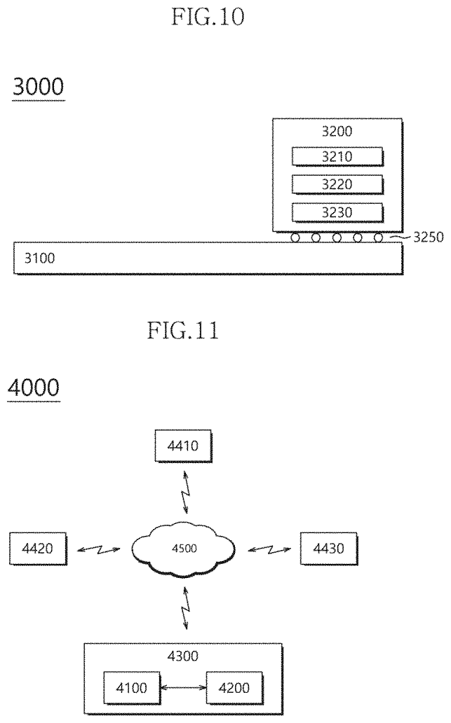

FIG. 10 is a diagram illustrating a data processing system 3000 including a memory system 3200 in accordance with an embodiment. Referring to FIG. 10, the data processing system 3000 may include a host device 3100 and the memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operations of the memory system 3200. The controller 3210 may be configured in the same manner as the controller 1210 shown in FIG. 8.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

FIG. 11 is a diagram illustrating a network system 4000 including a memory system 4200 in accordance with an embodiment. Referring to FIG. 11, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 10 shown in FIG. 1, the memory system 1200 shown in FIG. 8, the memory system 2200 shown in FIG. 9 or the memory system 3200 shown in FIG. 10.

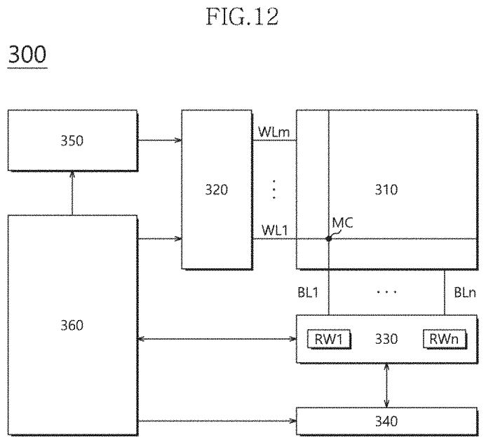

FIG. 12 is a block diagram illustrating a nonvolatile memory device 300 included in a memory system in accordance with an embodiment. Referring to FIG. 12, the nonvolatile memory device 300 may include a memory cell array 310, a row decoder 320, a data read/write block 330, a column decoder 340, a voltage generator 350, and control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/ write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

In accordance with embodiments, the memory system and the operating method thereof may reduce resource and power consumption by suppressing an unnecessary block migration operation.

While various embodiments have been illustrated and described, it will be understood to those skilled in the art in light of the present disclosure that the embodiments described are examples only. Accordingly, the memory system and the operating method thereof which are described herein should not be limited based on the described embodiments. Rather, the present invention is intended to embrace all modifications and variations of any of the disclosed embodiments that fall within the scope of the claims.

What is claimed is:

1. A memory system comprising:
a storage medium comprising a plurality of memory blocks each having a plurality of memory units; and
a controller configured to read target data of a target logical address corresponding to a read request from the storage medium,
wherein the controller comprises:
a unit count manager configured to manage a unit count of the target logical address in a unit count list, and decide whether to perform a unit migration operation on a target memory unit having the target data stored therein based on the unit count; and
a block count manager configured to manage a block count of a target memory block including the target memory unit in a block count list, and decide whether to perform a block migration operation on the target memory block based on the block count.

2. The memory system according to claim 1, wherein the unit count list comprises entries of a plurality of logical addresses corresponding to recent read requests received from a host device, and each of the entries comprises a corresponding unit count.

3. The memory system according to claim 2, wherein, when the unit count list is full and does not include an entry of the target logical address, the unit count manager deletes an entry of a victim logical address from the unit count list and inserts the entry of the target logical address into the unit count list.

4. The memory system according to claim 3, wherein the unit count manager selects a logical address corresponding to the oldest read request, among the logical addresses corresponding to the recent read requests, as the victim logical address.

5. The memory system according to claim 1, wherein the unit count manager decides to perform the unit migration operation when the unit count exceeds a unit threshold value.

6. The memory system according to claim 1, wherein the block count manager decides to perform the block migration operation when the block count exceeds a block threshold value.

7. The memory system according to claim 1, wherein the controller further comprises:
a buffer memory configured to temporarily store the target data read from the storage medium until being transferred to a host device; and
a unit migration component configured to perform the unit migration operation by storing the target data temporarily stored in the buffer memory into a new location of the storage medium.

8. The memory system according to claim 1, wherein the unit count manager deletes an entry of the target logical address from the unit count list, after the unit migration operation is performed on the target memory unit.

9. The memory system according to claim 1, wherein the block count manager resets the block count of the target memory block in the block count list, after the block migration operation is performed on the target memory block.

10. An operating method of a memory system which includes a storage medium including a plurality of memory blocks each having a plurality of memory units, and a controller configured to control the storage medium, the operating method comprising:
determining a unit count of a target logical address corresponding to a read request in a unit count list;
performing a unit migration operation on a target memory unit in which target data of the target logical address is stored based on the unit count;
determining a block count of a target memory block including the target memory unit in a block count list; and
performing a block migration operation on the target memory block based on the block count.

11. The operating method according to claim 10, wherein the unit count list comprises entries of a plurality of logical addresses corresponding to recent read requests received from a host device, and each of the entries comprises a corresponding unit count.

12. The operating method according to claim 11, further comprising, when the unit count list is full and does not include an entry of the target logical address, deleting an entry of a victim logical address from the unit count list and inserting the entry of the target logical address into the unit count list.

13. The operating method according to claim 12, further comprising selecting a logical address corresponding to the oldest read request, among the logical addresses corresponding to the recent read requests, as the victim logical address.

14. The operating method according to claim 10, wherein the performing of the unit migration operation comprises performing the unit migration operation when the unit count exceeds a unit threshold value.

15. The operating method according to claim 10, wherein the performing of the block migration operation comprises performing the block migration operation when the block count exceeds a block threshold value.

16. The operating method according to claim 10, further comprising:
performing a read operation on data of the target logical address stored in the storage medium; and
temporarily storing the data in a buffer memory included in the controller until the data is transferred to the host device,
wherein the performing of the unit migration operation comprises storing the data temporarily stored in the buffer memory into a new location of the storage medium.

17. The operating method according to claim 10, further comprising deleting an entry of the target logical address from the unit count list, after the unit migration operation is performed on the target memory unit.

18. The operating method according to claim 10, further comprising resetting the block count of the target memory block from the block count list, after the block migration operation is performed on the target memory block.
